(19) United States
(12) Patent Application Publication
(10) Pub. No.: US 2015/0330819 A1
(43) Pub. Date: Nov. 19, 2015

(54) MEASURING DEVICE, ESPECIALLY FLOW MEASURING DEVICE, AND METHOD FOR MANUFACTURING A MEASURING TUBE FOR A MEASURING DEVICE

(71) Applicant: Endress + Flowtec AG, Reinach (CH)

(72) Inventor: Oliver Berberig, Grenzach-Wyhlen (DE)

(21) Appl. No.: 14/712,048

(22) Filed: May 14, 2015

(30) Foreign Application Priority Data
May 16, 2014 (DE) 10 2014 106 927.7

(51) Int. Cl. G01F 1/66; B21J 5/00

(52) U.S. Cl. CPC G01F 1/667; G01F 1/662; B21J 5/00

(57) ABSTRACT

A measuring device, especially a flow measuring device, including a measuring tube. The measuring tube includes at least one nozzle formed from the measuring tube by hot forming and serving for mounting a measuring transducer, especially an ultrasonic transducer, a measurement signal reflector, especially an ultrasonic reflector, and/or a measurement transmitter, and a method for manufacturing a measuring tube for a measuring device.

The present invention relates to a measuring device and a method for manufacturing a measuring tube for a measuring device.

A measuring tube for a measuring device usually has nozzles, which are provided for the mounting of measuring transducers, respectively sensors, and measurement transmitters on the measuring tube.

These nozzles are usually welded to the measuring tube. A welded connection has, however, a variety of disadvantages. For instance, as a result of the high heat input during the welding, material distortion or warping can be experienced, which, as a rule, makes itself noticeable by a collapsing of the tube in the region of the nozzle welding. This can negatively influence the measuring performance.

Because this material distortion or warping depends, moreover, strongly on the details of the welding (e.g. welding speed, interpass temperature, etc.), and because nozzle weldings on flow measuring devices are, as a rule, manually executed, considerable geometric fluctuations can be experienced in the measured devices. This leads then to fluctuations in the measuring performance, which is inconsistent with reproducible batch production.

Furthermore, nozzles on flow measuring devices must typically be welded all the way through the wall, due to the specifications of standards. This leads especially in the case of pipes with significant wall thicknesses to multipass welding, which increases time and cost.

Cold forming methods are known for one-piece constructing of sensor nozzles on a measuring tube. There is no weld seam in such case. These methods are, however, only applicable in the case of measuring tubes having small wall thicknesses, so that measuring tubes for higher pressures cannot be manufactured therewith.

It is, consequently, an object of the present invention to provide a measuring tube with at least one nozzle, which is one-piece with the measuring tube and connected seamlessly with the measuring tube and which also can be implemented in the case of increased wall thicknesses, especially greater than 6 mm.

This object is achieved by a measuring device as defined in claim 1.

According to the invention, a measuring device, especially a flow measuring device, includes a measuring tube. This measuring tube includes at least one nozzle formed from the measuring tube by hot forming. The nozzle serves for mounting a measuring transducer, a measurement signal reflector, especially an ultrasonic reflector, and/or a measurement transmitter.

Hot forming methods have been known for a long time. An example of such a method is, for example, described by H. U. Stein in the article “Warmaushalsen von Behälterböden (hot necking of container floors” in “Chemie Ingenieur Technik (chemical engineering technology”, Vol. 41, 1969. Usually, a pipe is heated into the range, 1000° C. to 1200° C. This can occur, among other ways, by means of a gas burner.

Other than in the case of ordinary pipes, nozzles of measuring tubes have special requirements for exact orientation and formation, since the orientation of the nozzle, e.g. in the case of an ultrasonic, flow measuring device, determines the signal path of the ultrasonic signal. It has been found that hot forming is suitable for such nozzles.

Additionally, the hot forming enables the manufacture of one or more interfaces between tubular piece and sensor, respectively transducer element, without having to weld. Additionally, each nozzle is exactly positionable along the longitudinal axis of the measuring tube and in the circumferential direction.

The hot forming can additionally enable the manufacture of a pressure-bearing interface between tubular piece and sensor, respectively transducer element, with attention to the specifications of the relevant strength standards (e.g. PED, EN 13480, ASME B31.3) for a measuring tube.

The interface between tubular piece and sensor nozzle includes a flow friendly transition between tube and nozzle, inside the measuring tube. This may be of no great importance for an ordinary pipe, but, in the case of a measuring tube, the advantage is considerable for preventing flow disturbances in the region of the sensor.

Thus, complex subsequent processing of the surface inside the measuring tube is avoided. The manufacture of the measuring tube with the nozzle can, in such case, occur with production ready and well reproducible conditions.

Other advantageous embodiments of the invention are subject matter of the dependent claims.

It is advantageous when the nozzle manufacturing method permits a measuring tube wall of greater than 6 mm, especially greater than 10 mm. As a result, one measuring tube can serve for a large bandwidth of pressures. This provides a cost advantage in the case of small piece numbers. Additionally, measuring tubes with greater tube wall thicknesses are pressure stable and enable optimized flow at the sensors.

The outer neck radius r_{outneck} is preferably less than or equal to the neck height h. This enables, on the one hand, a sufficiently large nozzle cylinder surface for connecting, especially for pressure stable connecting, of transmitters, sensors and/or reflectors, to the measuring tube. On the other hand, this makes possible the application of simple semi-empirical equations for strength design of the nozzle.

In principle, tube branches lead to a weakening of the pressure resistance of the tube. In the case of a necked nozzle, however, the rounded transition between measuring tube and nozzle leads to a local stiffening, similar to the effect of a crimp in thin sheets. The pressure resistance is increased. This is especially of meaning for high pressure stages and enables the manufacture of branches coupled with a minimum material requirement. For accommodating and deflecting bending forces, it is advantageous when the radius of curvature of the transition is greater than the wall thickness.

Depending on manufacturing method, the wall thickness of the necked nozzle is less than the wall thickness of the measuring tube in a region in which no nozzle is arranged. However, this degrades the maximum achievable pressure only slightly.

The orientation of the sensor nozzle on the measuring tube is, for reasons of forming an exact signal path and obtaining reproducible manufacture, preferably exactly perpendicular to the measuring tube axis. The sensor nozzle has, consequently, a nozzle axis N and the measuring tube has a measuring tube axis M, wherein the nozzle axis N is advantageously perpendicular to the measuring tube axis M.

In tests, it has been found that known hot forming methods lead to the desired neck height h only in the case of larger nozzle dimensions, especially in the case of inner diameter greater than or equal to 60 mm. In order to obtain a sufficient neck height also in the case of smaller nozzles typical for sensors, preferably punches or dies are used. The use of punches and/or dies is so far not known in the case of hot forming. This practice enables the sufficiently precise forming also of smaller sensor nozzles, especially for meeting the requirement that the outer neck radius be less than or equal to the neck height.

The finished nozzle can advantageous have an external or internal thread. Likewise advantageously, it can have an outer chamfer as preparation for welding on of a nozzle cap or sensor.

It is especially advantageous when the nozzle has a planar end face, whose surface normal extends perpendicularly to the tube axis. This enables a precise connecting of sensors, reflectors or electronic housings.

Additionally, such an area can be used as a sealing surface: in order to prevent leakage of medium in the region of the interface between necked nozzle and nozzle cap, it is advantageous to provide a seal in the region of the end face.

Advantageously arranged within the planar end face can be a blind bore, which serves for mounting of a measuring transducer, respectively a sensor and/or a measurement transmitter, oriented with reference to the measuring tube axis.

The inner radius of the nozzle is advantageously selected in a defined relationship to the diameter of the measuring transducer and/or measurement transmitter arranged on the measuring tube.

The measuring tube is made of metal. Advantageously for corrosion resistance, the measuring tube is composed of steel, especially stainless steel.

According to the invention, in a method for manufacture of a measuring tube as claimed in one of the preceding claims, a punch and/or die is utilized.

A special feature of the method is especially that for achieving a neck geometry characterized by a relatively small outer radius of about 5-50 mm, a so-called necking die is used. This die is placed externally on the tube after the heating of the tube, clamped onto the tube, and then used as countercontour as the necking punch is drawn through. Alternatively, the necking punch can be used as counterpart for the die, which is pressed on the other side against the measuring tube.

The invention will now be explained in greater detail based on an example of an embodiment and with the aid of the drawing, the figures of which show as follows:

FIG. 1 a thick walled measuring tube with nozzles for the connection of sensor elements and/or an electronics housing;

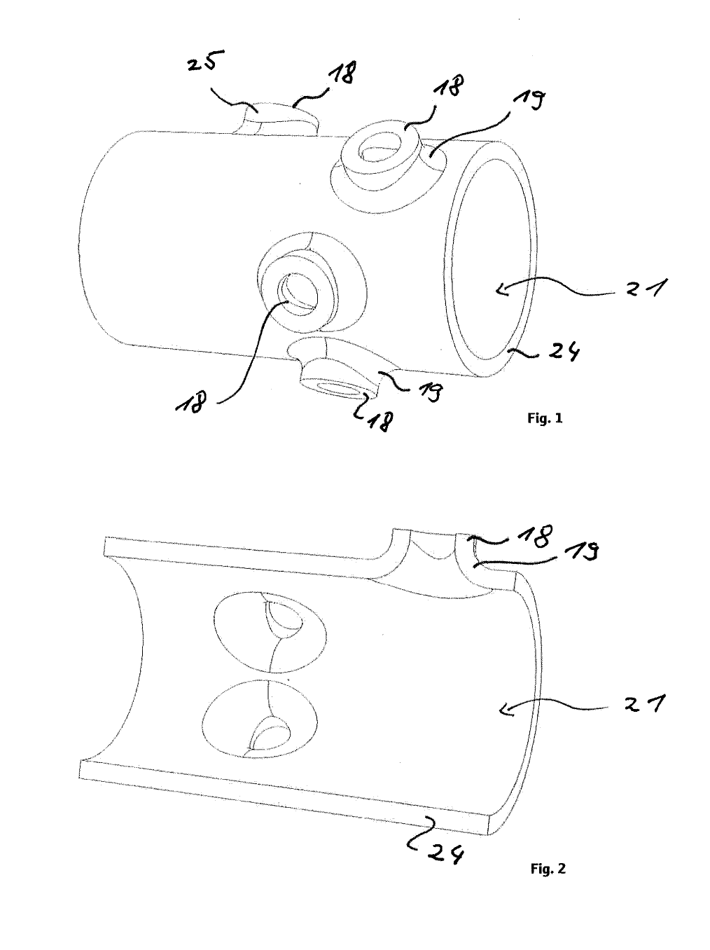

FIG. 2 sectional view of the measuring tube of FIG. 1;

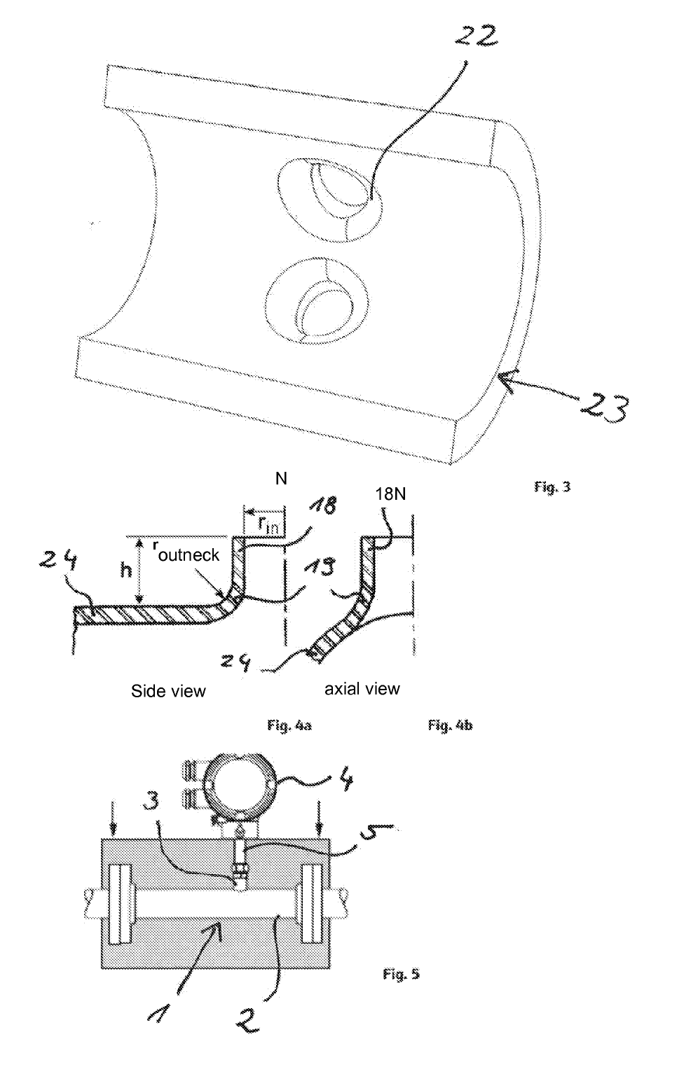

FIG. 3 die for forming the nozzle of FIG. 1;

FIG. 4a enlargement of the sectional view in the region of one of the nozzles with the cutting plane containing the measuring tube axis;

FIG. 4b enlargement of the sectional view in the region of one of the nozzles with the cutting plane extending perpendicularly to the measuring tube axis;

FIG. 5 schematic view of a thermal, flow measuring device; and

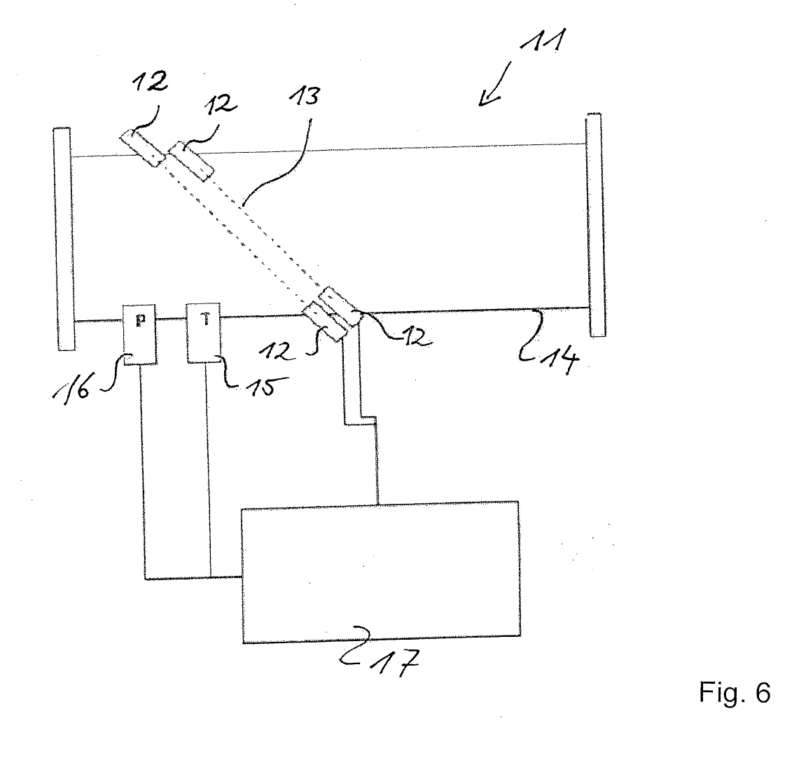

FIG. 6 schematic view of an ultrasonic, flow measuring device.

FIGS. 5 and 6 show flow measuring devices that work according to per se known measuring principles.

Both flow measuring devices can be embodied as so-called in-line measuring devices, which means that the sensor elements are in contact with the medium.

FIG. 5 shows a thermal, flow measuring device 1 having a measuring tube 2, wherein the measuring transducer of this device (not shown) protrudes inwardly into the measuring tube 2. The measuring transducer is connected with the measurement processor 4, the so-called transmitter, via a rod shaped element 5. The measuring tube 2 includes a nozzle 3, on which the arrangement of measuring transducer and measurement processor is mounted. The mounting must satisfy the pressure requirements of the respective application. This can be achieved e.g. by a screwed connection or a welding of the arrangement to the measuring tube 2.

FIG. 6 shows a schematic representation of an ultrasonic, flow measuring device 11 based on a measuring tube 14. It includes two ultrasonic transducer pairs. The number of ultrasonic transducers 12 and their arrangement on the measuring tube 14 can be very differently selected. FIG. 6 shows the ultrasonic signals being transmitted along a straight ultrasound paths 13 between, in each case, a transducer pair. Furthermore, there can be arranged on the measuring tube 14 other sensors, which are shown in FIG. 6 only by way of example, as pressure and temperature sensors and 16, respectively. The ultrasonic transducers 12 as well as the one or more additional, optional sensors 15 and 16 are connected with an evaluation unit 17. This can be embodied, for example, as part of a transmitter.

The ultrasonic transducers, the optional, additional sensors and, in given cases, also the transmitter unit are usually arranged via nozzles on the measuring tube 14.

One piece embodied, seamless, measuring tube nozzle arrangements are already state of the art in the case of thin measuring tube walls. These are produced by cold forming methods, such as e.g. hydroforming or deep drawing methods. A one-piece, seamlessly constructed nozzle on a measuring tube cannot, however, be cold formed in the case of measuring tubes with thick tube walls. Therefore, it is usual, in such case, to weld nozzles on the measuring tube, with all the known disadvantages.

FIGS. 1 and 2, 4a and 4b show a hot formed measuring tube 21. Formed on the measuring tube 21 is a nozzle 18. Arranged on this nozzle 18 can be a measuring transducer or a measurement transmitter. The mounting of a measuring transducer or a measurement transmitter can preferably occur by welding or by a screwed connection. In the case of the latter variant, preferably a screw thread is provided on the nozzle on its perimeter or on its inner circumference.

The transition 19 between the nozzle 18 and the measuring tube 21 is seamless and curved. The radius of curvature of the transition 19 is, in such case, preferably greater than the wall thickness of the measuring tube.

Measuring tube 21 should preferably have a measuring tube wall 24 of at least 6 mm thickness. The wall in the region of the nozzle 18 and the transition 19 has, in such case, a lesser wall thickness than the wall thickness of the measuring tube 17 in a region, in which no nozzle 18 is arranged. For reasons of pressure stability, it is, however, advantageous, when the wall thickness in the transition 19 is at least 80% of the wall thickness of the measuring tube in a region, in which no nozzle 18 is arranged.

Nozzle 18 has a nozzle axis N, which is perpendicular to the measuring tube axis M. Nozzles can be formed, for example, by heating the measuring tube to greater than 500°, preferably greater than 800°, especially greater than 950° C. Then, a mandrel is pressed from the inside against the measuring tube or externally pulled out, whereby a bulge formed. This produces the basic form of the nozzle. Nozzles 18 with small nozzle radii rᵢₙ, respective small nozzle inner diameters, can only be difficultly formed from the measuring tube. The reason for this is that the heating in the area of the desired nozzle cannot be kept as small as desired. So, if the mandrel is then pressed from inside against the tube wall, the wall deforms with a relatively large radius within the heated zone outwardly and leads to a T-joint with large outer radius r_{outneck} and small neck height h.

The desired forming can be simply and reliably achieved by using a die or a combination of a die and punch. A corresponding die is shown in FIG. 3. The die 23 includes, in such case, cavities 22 having the shape of the nozzle. The measuring tube wall 24 comes to rest against the walls of the cavities in the hot forming process.

FIGS. 1-4 show only a selected example of a measuring tube. The invention is not limited to the example. The number of nozzles can be variably selected. A measuring tube of the present invention can also have only one nozzle.

The forming of necks on pipes represents per se a known method, with which tube branching elements are produced. In such case, one distinguishes, in principle, between cold and hot forming methods.

In the case of cold necking, which is performed at room temperature, one is strongly limited as regards tube wall thickness due to the limited plasticity of the materials in the case of relatively small branch diameters. Typically, tube wall thicknesses to maximum 5 mm can be worked for branches suitable for ultrasonic transducers, with diameters of, for example, 20 to 40 mm.

In the case of hot necking, in contrast, branches with the aforementioned dimensions can also be implemented in thick-walled pipes, because, in such case, the material is heated e.g. up to almost 1000° C. and therewith possesses a high plasticity for the forming. DE 102008038889 A1 describes such a method. It is indicated there that the heating of the neck locations of pipes occurs with induction coils and that with this method wall thicknesses between 6 and 100 mm can be necked.

Such hot necked branching is typically used for the manufacture of branches, respectively T-joints, in the nominal diameter range between 100 and 1000 mm, such as are often required for gas pipelines. They have typically inner diameters of 60 mm and larger. For branches in flow meter measuring tubes, they are scarcely applicable, due to the large space requirement. Therefore, so far, no measuring tube manufactured by hot forming is known.

Hot forming enables especially flow friendly transitions between pipe and nozzle. Thus, this forming method is also suitable for forming nozzles of measuring tubes. In the document, H. U. Stein, “ Warmaushalsen von Behälterböden (hot necking of container floors” in “ Chemie Ingenieur Technik (chemical engineering technology”, Vol. 41, 1969, microstructure, macrostructure changes in the metal material are disclosed as proof of the verifiability of the hot forming method.

The hot forming method enables additionally preferably a defined contour of the nozzle instead of an undefined distortion, such as occurs in the case of manual welding.

The nozzle region has additionally from its crimp like, rounded contour a higher strength against bending forces than e.g. a conventional welded nozzle, which comparatively abruptly branches from the measuring tube.

By defined inner rounding of a necked nozzle, an inner working of the measuring tube can be omitted.

### REFERENCE CHARACTERS

1, 11 flow measuring device

2, 14, 21 measuring tube

3, 18, 22 nozzle

4 measurement transmitter

5 rod shaped element

12 ultrasonic transducer

13 ultrasound path

15 pressure sensor

16 temperature sensor

17 evaluation unit

19 transition

23 die

24 measuring tube wall/wall in general

25 cylindrical region

r_{outneck} outer radius

h neck height above tube exterior

M measuring tube axis

N neck axis

1-15. (canceled)

16. A measuring device, comprising:
a measuring tube, wherein said measuring tube includes at least one nozzle, formed from said measuring tube by hot forming;
an ultrasonic measuring transducer;
an ultrasonic measurement signal reflector; and/or
a measurement transmitter, wherein:
said nozzle serving to mount said ultrasonic measurement transducer

17. The measuring device as claimed in claim 16, wherein:
the transition between said measuring tube and said at least one nozzle is seamless and exhibits a microstructure, macrostructure change in the metal grain structure between said at least one nozzle and said measuring tube wall extending parallel to the axis of said measuring tube.

18. The measuring device as claimed in claim 16, wherein:
said measuring tube has a measuring tube wall thickness greater than or equal to 6 mm, especially greater than 10 mm.

19. The measuring device as claimed in claim 16, wherein:
an outer neck radius is less than or equal to a neck height.

20. The measuring device as claimed in claim 16, wherein:
the radius of curvature of the transition is greater than the wall thickness of said measuring tube wall.

21. The measuring device as claimed in claim 16, wherein:
the wall thickness of said at least one nozzle is less than the wall thickness of said measuring tube in a region in which no nozzle is arranged.

22. The measuring device as claimed in claim 16, wherein:
said at least one nozzle has a nozzle axis and said measuring tube has a measuring tube axis;
the nozzle axis is perpendicular to the measuring tube axis; and
preferably said at least one nozzle has on its upper end a cylindrical region, whose axis coincides with the nozzle axis.

23. The measuring device as claimed in claim 16, wherein:
said measuring tube has a nominal diameter of less than 100 mm.

24. The measuring device as claimed in claim 16, wherein:
said at least one nozzle has a screw thread and/or groove, which serves for securement of add-on parts.

25. The measuring device as claimed in claim 16, wherein:
said at least one nozzle has a planar end face, whose surface normal extends perpendicularly to the tube axis.

26. The measuring device as claimed in claim 25, wherein:
at or on said planar end face a seal is arranged, in order to prevent escape of process medium between said at least one nozzle and a sensor, respectively transducer.

27. The measuring device as claimed in claim 26, wherein:
within the planar end face a blind bore is arranged, which serves for mounting of said sensor, respectively transducer, oriented with reference to the tube axis.

28. The measuring device as claimed in claim 16, wherein:
the inner radius of said at least one nozzle is selected in a defined relationship to the diameter of said measuring transducer and/or measurement transmitter arranged on said measuring tube.

29. The measuring device as claimed in claim 16, wherein:
said measuring tube is made of metal, especially steel.

30. A method for manufacturing a measuring tube for a measuring device, said measuring device , comprising: said measuring tube, wherein said measuring tube includes at least one nozzle, formed from said measuring tube by hot forming; an ultrasonic measuring transducer; an ultrasonic measurement signal reflector; and or a measurement transmitter, wherein said nozzle serving to mount said ultrasonic measurement transducer, the method comprising the step of:
the hot forming is preformed by a die and/or a punch.
